(19) United States
(12) Patent Application Publication
(10) Pub. No.: US 2018/0302611 A1
(43) Pub. Date: Oct. 18, 2018

(54) 3D Time of Flight Camera and Method of Detecting Three-Dimensional Image Data

(71) Applicant: SICK AG, Waldkirch (DE)

(72) Inventors: Josef BAAK, Waldkirch (DE); Thorsten PFISTER, Waldkirch (DE)

(21) Appl. No.: 15/949,591

(22) Filed: Apr. 10, 2018

(30) Foreign Application Priority Data
Apr. 12, 2017 (DE) 102017107903.3

(51) Int. Cl. H04N 13/282; G01S 17/89; G01S 7/51; G01S 7/481; H04N 13/257; H04N 13/296

(52) U.S. Cl. CPC H04N 13/282; G01S 17/89; H04N 13/296; G01S 7/4813; H04N 13/257; G01S 7/51

(57) ABSTRACT

A 3D time of flight camera is provided for detecting three-dimensional image data from a detection zone having a plurality of time of flight modules for detecting a partial field of view of the detection zone that each have an image sensor, a reception optics, and an interface for outputting raw image data and having at least one illumination module for transmitting a light signal into the detection zone. The 3D time of flight camera comprises a central control and evaluation unit that is connected to the time of flight modules and to the illumination modules to receive the raw image data and to generate the three-dimensional image data therefrom; a common connector for outputting three-dimensional image data and/or data derived therefrom; and a common housing in which the time of flight modules, the at least one illumination module, and the central control and evaluation unit are accommodated.

The invention relates to a 3D time of flight camera for detecting three-dimensional images from a detection zone having a plurality of time of flight modules for detecting a partial field of view of the detection zone that each have an image sensor, a reception optics, and an interface for outputting raw image data and having at least one illumination module for transmitting a light signal into the detection zone. The invention further relates to a method of detecting three-dimensional image data from a detection zone, wherein raw image data from a plurality of partial fields of view of the detection zone are detected separately.

Unlike a conventional camera, a 3D camera also records depth information and thus generates three-dimensional image data having spacing values or distance values for the individual pixels of the 3D image which is also called a distance image or a depth map. The additional distance dimension can be utilized in a number of applications to obtain more information on objects in the scene detected by the camera and thus to satisfy different objects.

In automation technology, objects can be detected and classified with respect to three-dimensional image data in order to make further automatic processing steps dependent on which objects were recognized, preferably including their positions and orientations. The control of robots or different types of actuators at a conveyor belt can thus be assisted, for example.

In vehicles that operate on public roads or in a closed environment, especially in the field of factory and logistics automation, the total environment and in particular a planned travel path should be detected as completely as possible and in three dimensions using a 3D camera. This applies to practically all conceivable vehicles, whether those with operators such as passenger vehicles, trucks, work machines and fork-lift trucks or driverless vehicles such as AGVs (automated guided vehicles) or floor-level conveyors. The image data are used to enable autonomous navigation or to assist an operator to inter alia recognize obstacles, to avoid collisions, or to facilitate the loading and unloading of transport products including cardboard boxes, pallets, containers, or trailers.

Different processes are known for determining the depth information such as time of flight measurements or stereoscopy. A scene is illuminated by amplitude-modulated light in the time of flight (TOF) measurement looked at here. The camera measures the time of flight of the reflected light for every picture element. In a pulse process, light pulses are transmitted for this purpose and the time between the transmission and the reception is measured. On the use of detector arrays—in particular 2D CCD or CMOS image sensors—this can also be done indirectly by means of the so-called shutter principle in which the detector array is exposed for a defined period (shutter time) after transmission of the light pulse so that a differently large proportion of the pulse energy reflected back from the measured object is integrated in the individual detector pixels in dependence on the pulse time of flight. The influence of the absolute value of the pulse energy that arrives at the detector and that is inter alia dependent on the object remission can be eliminated in that two measurements are carried out with shutter times offset relative to the pulse transmission whose results are subsequently combined with one another or are put into a relationship with one another. In a phase process, a periodic amplitude modulation and measurement of the phase offset between the transmitted light and the received light takes place. One technology for the acquisition of three-dimensional image data using a phase process is photomixing detection (PMD).

A 3D camera requires a large field of view (FOV) of different sizes depending on the application. In autonomous vehicles, 3D cameras having a wide field of view (WFOV) are used to avoid collisions. The aperture angle of the reception optics amounts to 70°×60° and more in this case. On the inspection of packages in the consumer goods industry, a narrower field of view is sufficient; the aperture angle is typically approximately 40°×30° (narrow field of view, NFOV). In a further application in traffic monitoring and vehicle measurement of trucks, a laterally very wide and vertically narrow field of view of approximately 120°×30° is required.

The conventional solution approach is to provide different camera variants having aperture angles of different amounts for the different applications. This is inflexible and costly and/or complex. A large number of variants have to be managed, produced and stored on the side of the manufacturer. The user cannot react to changes of his application, but must rather order the respective matching variant.

In addition, with a given image sensor, the spatial resolution is reduced with a wider field of view since the number of pixels remains the same. This effect results in a dramatic reduction in spatial resolution with said WFOV camera. In addition, the robustness with respect to extraneous light is generally worse. Required objectives having short focal lengths and a high speed (small f-number) are not generally available, but require a complex and/or costly objective development. In the application example in traffic monitoring, the field of view has a different aspect ratio than typical image sensors, namely the field of view 4:1 and a common image sensor 4:3 or 5:4. This must either be achieved with a special development of the optics or only one image section (region of interest, ROI) is used and the image sensor is thus not used efficiently.

Even the aperture angle of a WFOV variant is not large enough in some applications. One known alternative is then to combine a plurality of 3D cameras. Their measurement data have to be combined and evaluated in a separate central evaluation unit. The user acquires the wide field of view through a number of disadvantages. An expensive additional central evaluation unit is first required for which software algorithms also have to be developed and implemented on the user side before a practical use. This does not only relate to the evaluation, but also to the control to enable an interplay of the cameras above all with respect to the precise synchronization. The installation, including wiring, assembly, adjustment, and the putting into operation with calibration of the relative positions and orientations of the individual cameras toward one another is then extremely laborious.

US 2011/0109748 A1 discloses a camera array of a number of TOF cameras that are arranged in a circle around an object to record it from different angles. It is in this respect a question of independent cameras having the disadvantages described in the previous paragraph.

EP 2 546 776 B1 discloses a camera-based code reader having a plurality of linear image sensors in a common base body which superpose their individual reading fields to form a linear reading field. The concept is suitable for a special application of the code reading at a conveyor belt, but not for the detection of three-dimensional image data using a variable or extendable field of view.

It is therefore the object of the invention to provide an improved 3D time of flight camera.

This object is satisfied by a 3D time of flight camera and by a method of detecting three-dimensional images from a detection zone in accordance with the respective independent claim. The 3D time of flight camera has at least one illumination module and a plurality of time of flight modules, that is at least two or even more, for the detection of raw image data for determining the time of flight for the distance measurement in each case for a partial field of view of the detection zone, with the partial fields of vision overlapping one another or not depending on the embodiment. Depending on the embodiment, the illumination modules are directly associated with one time of flight module, are responsible for a plurality of time of flight modules, or conversely a plurality of illumination modules are provided for one time of flight module. The time of flight modules each comprise an image sensor, a reception optics, and an interface for outputting the raw image data. To determine a time of flight using the raw image data, a time of flight unit is preferably provided in the time of flight modules and can be separately or at least partly integrated in the image sensor. The time of flight process is generally of an arbitrary kind, but is preferably phase based and is in particular the PMD process mentioned in the introduction or is also pulse based, in particular using the shutter principle mentioned in the introduction.

The invention now starts from the basic idea of connecting the time of flight modules via a central control and evaluation unit to the 3D camera using a common connector in a common housing. The time of flight modules are connected to the central control and evaluation unit for this purpose. An indirect connection, for example, via another time of flight module or illumination module is initially sufficient for this purpose, but each module is preferably directly connected to the central control and evaluation unit, which then produces a star topology.

The central control and evaluation unit collects the raw image data of the time of flight modules and generates the three-dimensional image data therefrom. This can be preceded by previous work and can be succeeded by postprocessing steps or by an application-specific evaluation of the three-dimensional image data. The central control and evaluation unit also coordinates the recordings by the time of flight modules and the transmission of the raw image data and can synchronize the various modules with one another. The central control and evaluation unit outputs at least some of the three-dimensional image data and/or results of their evaluations via a common connector and thus has a central interface for the whole 3D time of flight camera. The same preferably applies accordingly to a common energy supply. All the modules are accommodated with the central control and evaluation unit in a common housing. The system consequently represents a single 3D time of flight camera toward the outside.

The invention has the advantage that the most varied fields of view can be set in an extremely variable manner by the modular design. This variability and the possible effective aperture angle also go far beyond the possibilities of a WFOV camera. The aspect ratio, that is the ratio of width to height, can also be selected flexibly. Unlike with a WFOV camera, the spatial resolution is maintained with such extensions and adaptations. Despite these improvements, the individual time of flight modules remain very simple, small in construction, and inexpensive. A simpler NFOV objective design is sufficient for the respective partial field of view region with a selection of comparatively inexpensive standard components that are potentially available without any development effort and with less distortion and marginal light fall-off to be mastered. Corresponding advantages apply to the at least one illumination module since a homogeneous illumination can be implemented considerably easier in a small field of view. The increased robustness toward extraneous light is a further advantage. On the one hand, the angle of incidence spectrum is small and permits smaller filter bandwidths. In addition, the area of the scene from which each pixel of an image sensor collects light in the time of flight modules is smaller than with a WFOV camera.

The 3D time of flight camera is complex and inexpensive overall. Short signal paths results due to a favorable construction arrangement of the modules with respect to one another and to the central control and evaluation unit. It can be installed in a very simple manner. Due to the common connector, there is no special wiring effort; the time of flight modules and illumination modules are internally connected and aligned so that no adjustment beyond an alignment of the 3D time of flight camera as a whole is required. All the components are combined in one unit that is protected by a robust and compact housing.

The common housing preferably has the shape of a regular n-gon where n>4 as its base area and the time of flight modules are arranged at at least some sides of the n-gon and are outwardly oriented. This permits a very compact and flat manner of construction. Fewer sides are conceivable in principle, but are not advantageous because then a single time of flight module would have to cover too large an angle of view. A number of variants in the same housing concept are conceivable that each actually occupy more or fewer sides of the housing with time of flight modules, up to an effective all-round view of 360°. At least one illumination module is preferably arranged with a respective time of flight module.

The time of flight modules preferably have a housing having a base area in the form of a trapezoid or of a triangle matching a segment between the center and two adjacent corners of the n-gon. A triangular segment of the n-gon thereby arises in a first approximation similar to a slice of cake that covers 360°/n. Certain tolerances for the insertion are preferably set. In addition, the inner tip of the triangle is preferably cut off, which then produces a trapezoidal shape. Space for connectors and for the central control and evaluation unit thereby arises in the center.

Some time of flight modules are preferably, and even more preferably all the time of flight modules, are combined with a separate illumination module, in particular in a common module housing. This substantially facilitates the time-critical synchronization between the illumination and the recording that can then take place locally within the time of flight module. A corresponding module control unit is preferably provided in the time of flight module for this purpose. The activity of the time of flight modules can be separated in various ways such as spatially separate visual fields, different time slots, modulation frequencies or codings. If, alternatively, time of flight modules and illumination modules are not combined with one another, the synchronization has to take place via the central control and evaluation unit or one module acts as a master. A central synchronization is possible, but complex and/or expensive, even for combined time of flight modules and illumination modules.

The partial fields of view of the time of flight modules are preferably different and complement one another to form the detection zone. The partial fields of view are thus per se smaller the detection zone. A larger field of view is assembled in modular form from partial fields of view and with the above-described advantages with respect to a single WFOV camera. In this respect, the partial fields of view complement one another along one or two dimensions, i.e. horizontally or vertically or horizontally and vertically, to form the larger total detection zone.

At least some of the partial fields of view preferably at least partly overlap one another. A higher resolution or pixel density results from this; in addition, disadvantageous effects such as very dark objects or less remitting objects, shading, gloss or multi-path effects can be compensated by the redundant detection. In some embodiments, two or even more time of flight modules have a substantially complete overlap and thus observe the same partial field of view that in the extreme case simultaneously corresponds to the detection zone. Offset arrangements are, however, also conceivable in which partial fields of view overlap in an interleaved manner to different degrees. Even if per se no redundant monitoring is aimed for, but the partial fields of view should rather complement one another to form a large detection zone, an overlap at the margins instead of partial fields of view exactly adjoining one another can be advantageous. The overlap can be easily corrected during data fusion using a calibration of the arrangement and orientation of the time of flight modules. The overlap for this purpose enables a marginal zone drop to be compensated and the detection capability to be increased and interference sources in such marginal zones to be identified.

At least some of the time of flight modules and/or the at least one illumination module preferably have/has a movement unit for changing the partial field of view. It is in this respect a mechanical actuator system, but preferably an electronic adjustment option, for example using a piezo actuator. The partial fields of view are thereby variable, both during setup and adjustment and during a reconfiguration of the application or even dynamically in operation. The orientation is preferably tilted by the movement, but a lateral movement or a rotation is also conceivable.

The central control and evaluation unit preferably has an image date flow control to read the raw image data from the time of flight modules in a coordinated manner. When reading the raw image data, a large data flow arises that is controlled by the central control and evaluation unit in this manner with a utilization of the resources and bandwidths that is as optimum as possible.

The image data flow control preferably has a multiplex unit for a sequential reading of raw image data from a respective other time of flight module. The time of flight modules are thereby read in an order and there are only moderate demands on the bandwidth and processing speed of the raw image data.

The image data flow control preferably has a plurality of channels. Raw image data can thus be read from a plurality of time of flight modules, at least two time of flight modules, simultaneously or sequentially. A shorter processing time and ultimately a higher image recording frequency thus become possible or a slower reading speed with otherwise unchanged conditions is sufficient. Corresponding modules (bridge) for reading two image data streams of two image sensors are available and such a solution can thus be implemented in an inexpensive manner. It is not necessary that there are as many channels as time of flight modules, but two respective channels can rather be operated simultaneously, for example, and can be switched over by multiplexing.

The central control and evaluation unit is preferably configured for a preparation of raw image data that comprises at least one of the steps of correction of objective distortion of the reception optics, compensation of drifts, correction of the arrangement of the time of flight modules with respect to one another in position and/or orientation, or consideration of calibration data. The raw image data are thus subjected to a preprocessing prior to the fusion in the three-dimensional image data. Depending on which raw image data the time of flight module delivers, distance values or depth values are here also calculated for the respective partial field of view or they are already included in the raw image data. It is also possible to combine a plurality of recordings with one another as with HDR (high dynamic range) imaging. A data fusion for the whole system then preferably follows in which three-dimensional image data of the detection zone or selected details therein, regions of interest, ROIs) are generated from the preprocessed raw image data of the partial fields of view.

The central control and evaluation unit is preferably configured for a postprocessing of the three-dimensional image data after the fusion of the raw image data, in particular a data compression, a selection of regions of interest, an object recognition or an object tracking. In this postprocessing, subsequent image processing steps can follow the three-dimensional image data, for instance a data compression for an output to the common connector, an object recognition, an object tracking, or even application-specific evaluations that prepare or even already implement the actual evaluation goal of the application.

The method in accordance with the invention can be further developed in a similar manner and shows similar advantages in so doing. Such advantageous features are described in an exemplary, but not exclusive, manner in the subordinate claims dependent on the independent claims.

The invention will be explained in more detail in the following also with respect to further features and advantages by way of example with reference to embodiments and to the enclosed drawing. The Figures of the drawing show in:

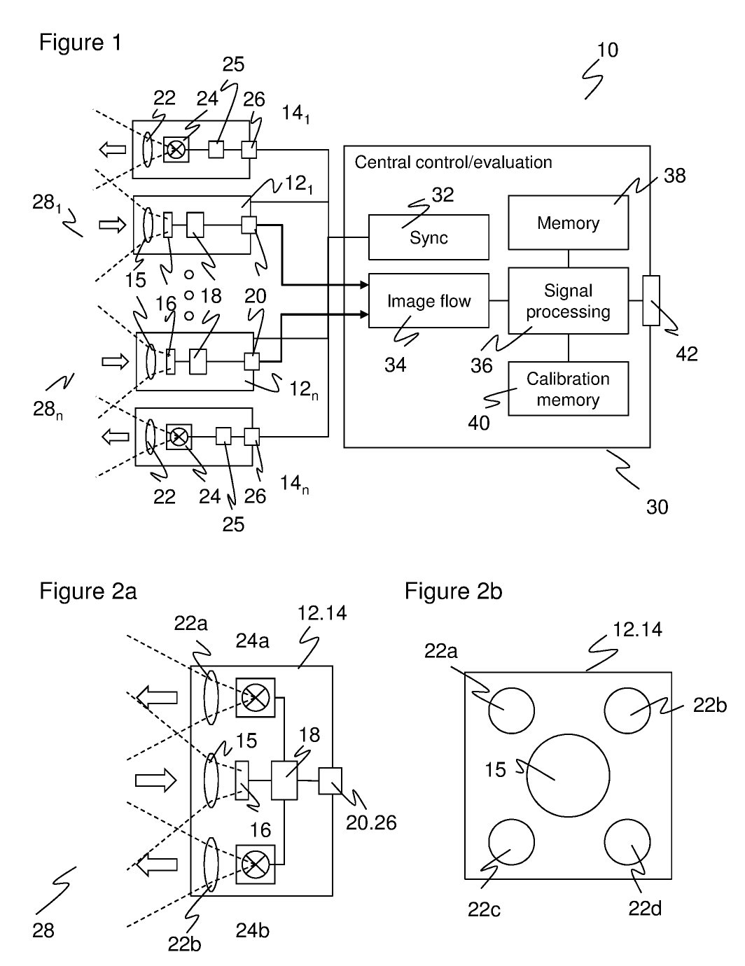

FIG. 1 a block diagram of an embodiment of a 3D time of flight camera having a plurality of time of flight modules and illumination modules and a central control and evaluation unit;

FIG. 2a a block diagram of a combined time of flight module and illumination module;

FIG. 2b a front view of the combined time of flight module and illumination module in accordance with FIG. 2a;

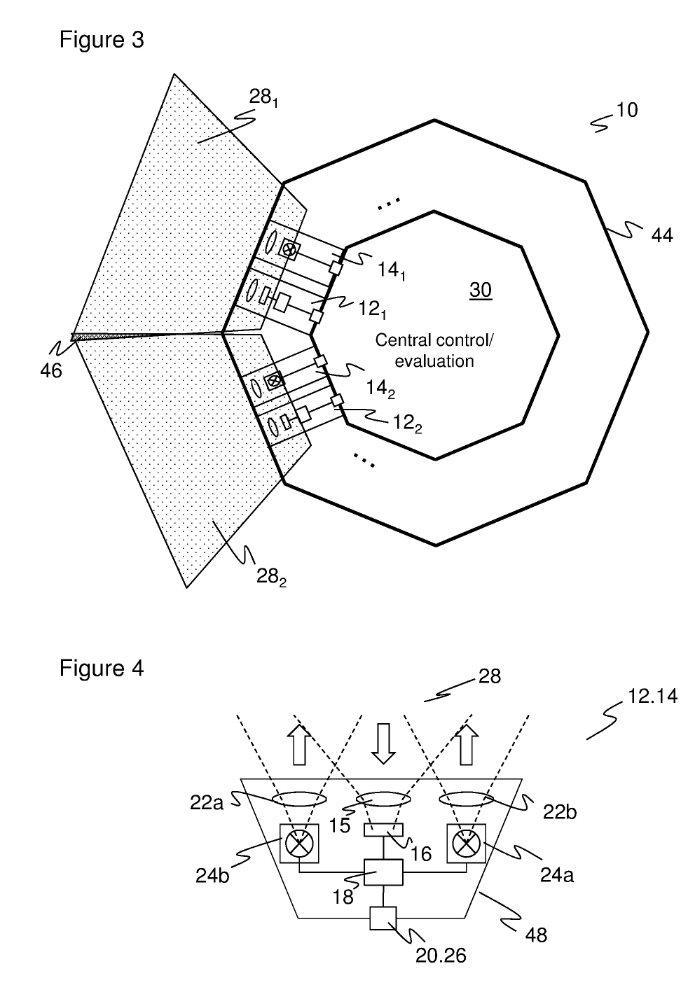

FIG. 3 a schematic plan view of a 3D time of flight camera having an octagonal basic housing shape, with two sides being occupied with time of flight modules and illumination modules by way of example;

FIG. 4 a schematic plan view of a combined time of flight module and illumination module with a module housing matching the octagonal basic housing shape in accordance with FIG. 3;

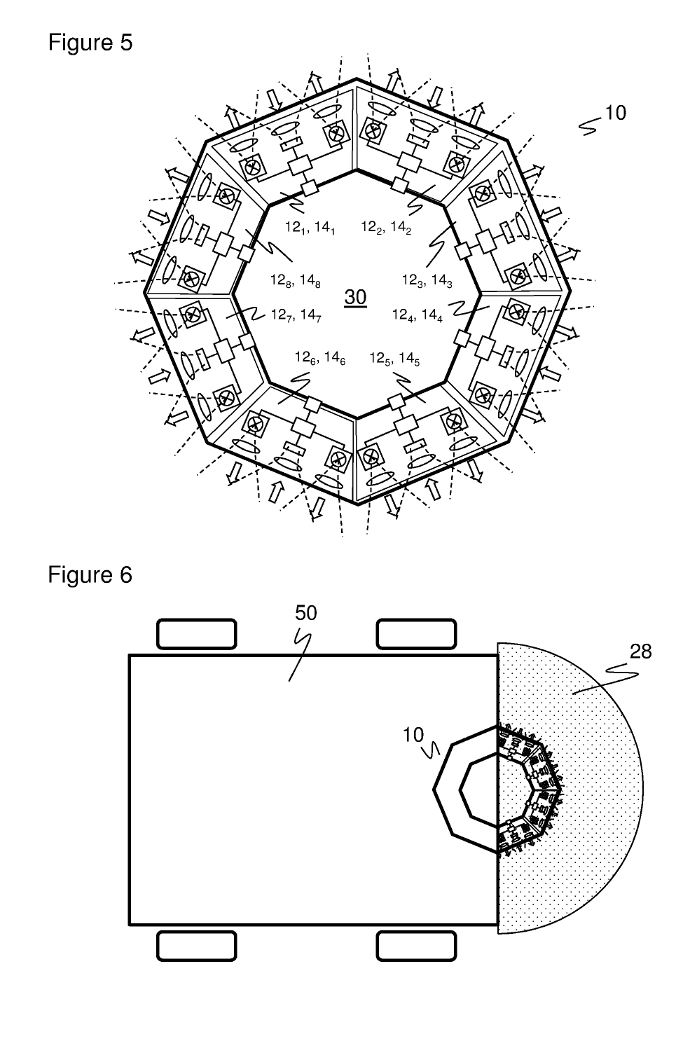

FIG. 5 a schematic plan view of a 3D time of flight camera having an octagonal basic housing shape similar to FIG. 3, but with a 360° field of view by occupying all sides with time of flight modules and illumination modules;

FIG. 6 a schematic plan view of a vehicle having a 3D time of flight camera with a 180° field of view;

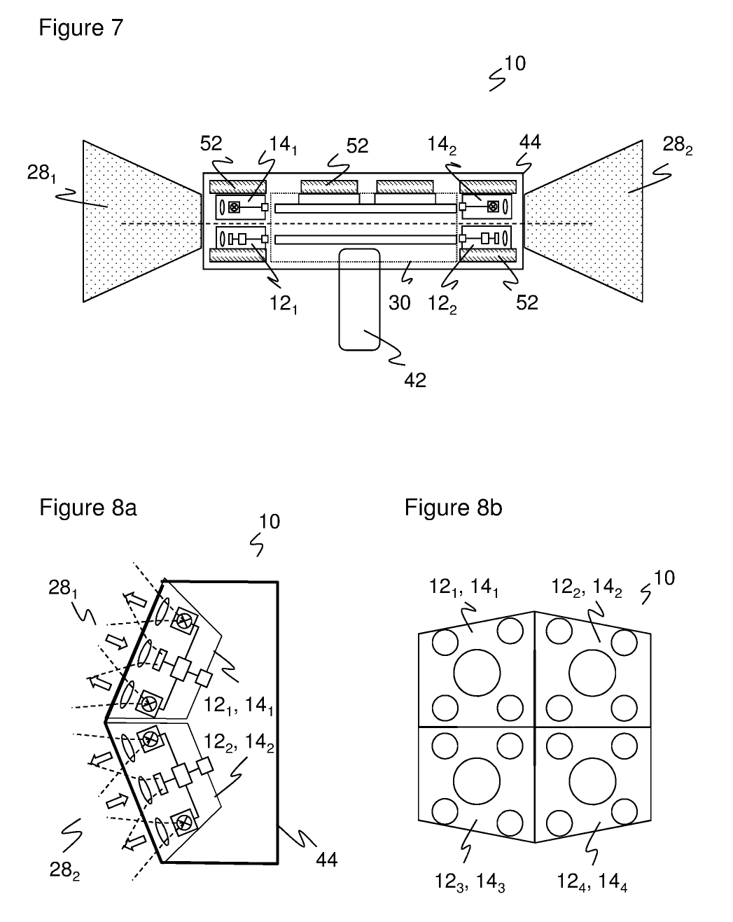

FIG. 7 a schematic sectional view of the 3D time of flight camera in accordance with FIG. 6, but with the illumination module being arranged above instead of next to the associated time of flight module;

FIG. 8a a schematic plan view of a further embodiment of a 3D time of flight camera now with stacked time of flight modules and illumination modules to expand the field of view in elevation;

FIG. 8b a front view of the 3D time of flight camera in accordance with FIG. 8a;

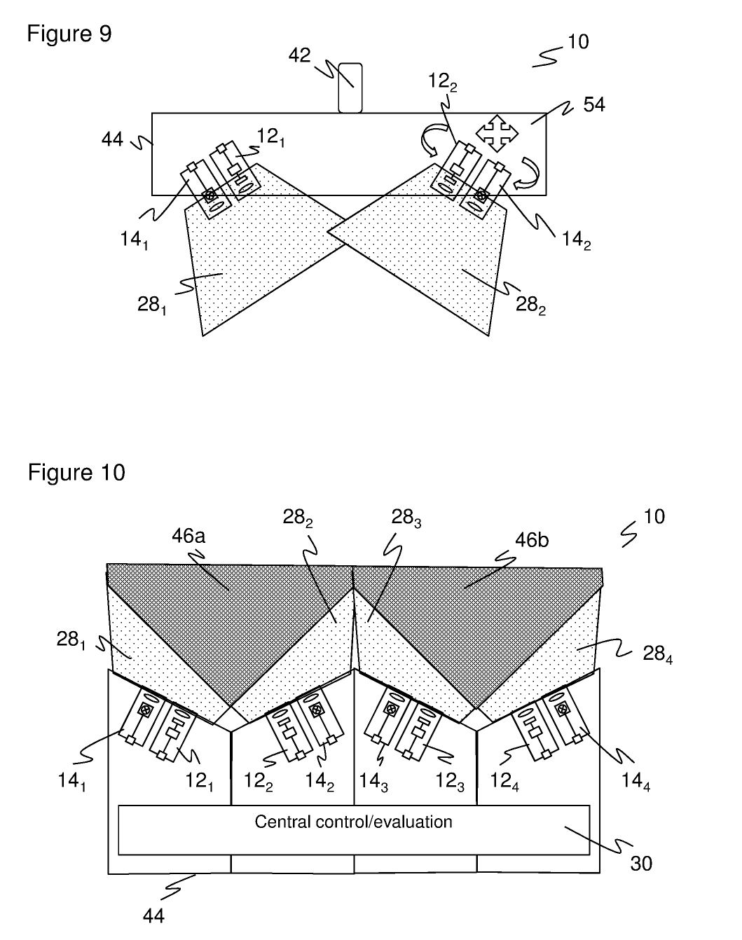

FIG. 9 a schematic plan view of a further embodiment of a 3D time of flight camera having two time of flight modules and illumination modules whose partial fields of view overlap one another; and

FIG. 10 a schematic plan view of a further embodiment of a 3D time of flight camera having four time of flight modules and illumination modules in a mixed arrangement of mutually overlapping and complementing partial fields of view.

FIG. 1 shows a block diagram of a 3D camera 10 that has a plurality of time of flight modules 12_{1 . . . n} with which respective illumination modules 14_{1 . . . n} are associated. The shown direct association of time of flight modules 12_{1 . . . n} and illumination modules 14_{1 . . . n} is advantageous, but it is also conceivable in other embodiments that illumination modules 14_{1 . . . n} are responsible for a plurality of time of flight modules 12_{1 . . . n} or conversely a plurality of illumination modules 14_{1 . . . n} belong to one time of flight module 12_{1 . . . n}.

The time of flight modules 12_{1 . . . n} each comprise a reception optics 15, an image sensor 16 having a plurality of pixels arranged to form a matrix, for example, a time of flight unit 18, and an interface 20 for outputting raw image data. Objectives having a small aperture angle are preferably used as reception optics 15. In addition, the reception optics 15 preferably comprises optical filters (e.g. bandpass filters for suppressing interfering light sources) and optionally further or other refractive, reflective, or diffractive optical elements, optionally having special coatings. The separation into an image sensor 16 and a separate time of flight unit 18 is admittedly possible, but rather serves for an understandable explanation. The functionality of the time of flight unit 18 is preferably integrated into the pixels or into the image sensor 16. The interface 20 can also be a function of the image sensor 16. The illumination modules 14_{1 . . . n} each have a transmission optics 22, a light transmitter 24 having at least one light source, for example LEDs or lasers (for example edge emitters or VCSEL arrays) and a driver 25 for the control and modulation, as well as a connector 26 for controlling the illumination. The transmission optics 22 can consist of refractive and/or diffractive optical elements (e.g. lens or objective) and/or of mirror optics (reflectors) and/or diffusers. The transmission optics 22 can furthermore be integrated directly into the light transmitter 24 or can be connected by this to a component (e.g. LED having an integrated lens or VCSEL array with a downstream diffuser that is integrated in the package).

In operation, the individual partial visual fields 28_{1 . . . n} of the time of flight modules 12_{1 . . . n} are illuminated with pulsed or periodically modulated light signals by the illumination modules 14_{1 . . . n} and the time of flight units 18 determine the raw image data from the received signals of the pixels of the respective image sensors 16, in which raw image data the information on the time of flight (TOF) of the light signals up to an object and back with respect to the pixels or pixel groups is included. The object distance can then be calculated from this using the speed of light. Such time of flight measurements are known per se; three non-exclusive examples are a direct time of flight measurement by TDCs (time to digital converters) in a pulse process; an indirect pulse time of flight measurement using CMOS pixels or CCD pixels by means of the shutter principle as initially described; or photomixing detection in a phase process (TDC). In some embodiments, the time of flight only results after a statistical evaluation of a plurality of events or pixels to compensate noise influences due to effects such as environmental light or dark count rates, in particular in the case of SPADs (single photon avalanche diodes). The 3D camera 10 becomes a multi-aperture camera that combines the individual partial fields of view 28_{1 . . . n} by the plurality of time of flight modules 12_{1 . . . n}. In this respect, due to the plurality of time of flight modules 12_{1 . . . n}, an expanded field of view can be achieved with an unchanging lateral spatial resolution.

The time of flight modules 12_{1 . . . n} and illumination modules 14_{1 . . . n} are connected to a central control and evaluation unit 30. A plurality of functional blocks are represented therein by way of example to explain the objectives of the central control and evaluation unit 30.

A synchronization unit 32 controls the time behavior of the connected modules 12_{1 . . . n}, 14_{1 . . . n} and performs further control work such as a configuration or the specification of a specific modulation behavior. Different embodiments are conceivable in this respect. On the one hand, a plurality of modules or all the modules 12_{1 . . . n}, 14_{1 . . . n} can actually be activated centrally simultaneously. A plurality of illumination modules or all the illumination modules 14_{1 . . . n} together then act as a large illumination, with differences in properties such as spectrum, power, or modulation still being conceivable, and the time of flight modules 12_{1 . . . n} record raw image data simultaneously. A sequential recording of the raw image data of individual time of flight modules or of all time of flight modules 12_{1 . . . n} is, however, also conceivable.

In other embodiments, the particularly time-critical synchronization between the time of flight module 12_{1 . . . n} and the associated illumination module 14_{1 . . . n} takes place locally in the modules that therefore work independently with respect to illumination and image recording. A highly precise central synchronization is then not necessary. A mutual influencing can be avoided by means of a channel separation in the time range (time multiplex), frequency range (choice of different modulation frequencies), by means of code multiplex or spatially by non-overlapping partial fields of view 28_{1 . . . n} or also by combinations thereof. Mixed forms of central and local synchronization are also conceivable.

An image data flow control 34 or bridge is connected to the interfaces 20 of the time of flight modules 12_{1 . . . n} to read the raw image data. The transmission preferably takes place serially (for example MIPI, mobile industry processor interface). As already explained, the raw image data are data having distance information such as phase data or time of flight data, not yet corrected. In an embodiment, the image data flow control 34 forwards raw data from a respective time of flight module 12_{1 . . . n} by means of multiplexing so that always only one channel is therefore active. Alternatively, the raw data are combined and placed at one output. If a multichannel evaluation is arranged downstream, correspondingly more channels can be forwarded simultaneously or the image flow control 34 is completely omitted with sufficient evaluation channels.

A signal processing unit 36 receives the raw image data. For a faster image processing, the signal processing unit 36 can be configured to process a plurality of image streams. A CPU or an FPGA or a combination of CPU and FPGA (e.g. ZYNQ) having at least two MIPI inputs is in particular provided or this purpose. Additionally or alternatively, a GPU can also be utilized. The signal processing unit 36 is connected to a memory 38 to store raw image data and evaluation results. In addition, a calibration memory 40 is provided that can also be formed together with the memory 38 and from which the signal processing unit 36 reads in various calibration data and other parameters as required.

The signal processing unit 36 processes the raw image data in a plurality of steps which do not, however, all have to be implemented. An exemplary processing chain comprises a preprocessing of the raw image data still belonging to a time of flight module 12_{1 . . . n}, a fusion into common three-dimensional image data, their postprocessing, and optionally evaluation algorithms related to the specific application. In the preprocessing or preparation of the raw image data, object distortion of the reception optics 14 is corrected, for example; drifts, in particular due to temperature, are compensated; and possibly a plurality of raw images are combined together (HDR, measurement range extension or ambivalence suppression). Subsequently, unambiguous and corrected depth values of the respective time of flight module 12_{1 . . . n} are acquired. Prior to the fusion, the orientation of the time of flight modules 12_{1 . . . n} with respect to one another or another calibration can be taken into account.

The depth values of the individual time of flight modules 12_{1 . . . n} thus acquired are then fused to form three-dimensional image data of a common field of view of the 3D camera 10. In the postprocessing, corrections can again be carried out, for example redundant image information in overlap regions can be utilized; in addition various filters can be used. Finally, already application-specific or preparatory evaluation steps of the acquired three-dimensional image data are also conceivable such as the selection of image sections (regions of interest, ROIs), data compression, conversion into a desired output format, object recognition, object tracking, and the like.

The three-dimensional image data or data acquired therefrom are then available at a common connector 42 of the 3D camera 10. Further common connectors, not shown, are conceivable. They include a power supply that can, however, also be integrated in the common connector 42 (for instance power over Ethernet). If parameters can be set in the signal processing unit 36 or if corresponding evaluations can take place, the 3D camera 10 can also have analog or digital inputs and outputs, in particular switching outputs, that can be conducted via a cable together with the power supply, for example.

From a mechanical aspect, a common housing, not shown in FIG. 1, is furthermore provided which preferably also enables a simple installation of the 3D camera 10. The 3D camera 10 thus represents a uniform system toward the outside having an extended field of view that is composed of simple modules 12_{1 . . . n}, 14_{1 . . . n} and their partial fields of view 28_{1 . . . n}.

The image recording by the modules 12_{1 . . . n}, 14_{1 . . . n} can take place sequentially, for example in a cycle, by the time of flight modules 12_{1 . . . n} and by the respective associated illumination modules 14_{1 . . . n}. It is also conceivable to control time of flight modules 12_{1 . . . n} independently of the associated illumination modules 14_{1 . . . n} to recognize optically interfering sources such as reflective objects. Alternatively, images are recorded synchronously by at least some time of flight modules 12_{1 . . . n} and respective associated illumination modules 14_{1 . . . n}. A time displacement is thus prevented with a fast-moving object. In addition, the illumination power is thus inflated in overlapping parts of visual fields 28_{1 . . . n}, which reduces or even compensates the typical marginal light drop of the individual illumination modules 14_{1 . . . n}.

Individual modules 12_{1 . . . n}, 14_{1 . . . n} can be selectively switched on and off as required depending on the situation to save energy, for instance on a vehicle in dependence on the direction of travel or with conveyor belt applications for a predetection in which only outer modules 12_{1 . . . n}, 14_{1 . . . n} are active, and generally in particular with static applications when it is known that a measurement is only necessary in specific partial fields of view 28_{1 . . . n}. A partial switching off of light sources within an illumination module 14_{1 . . . n} is also conceivable if a rough recognition in an energy saving mode is sufficient.

In the block diagram of FIG. 1, the time of flight modules 12_{1 . . . n} and the illumination modules 14_{1 . . . n} are each independent modules that are separately connected to the central control and evaluation unit 30. This has the advantage of a high flexibility on a control and synchronization, but simultaneously makes high demands on the synchronization of the illumination and image recording.

FIG. 2a shows a block diagram of a time of flight module 12 that is configured as a common module with the associated illumination module 14. This can no longer be controlled so flexibly. The demands on synchronization are in turn considerably reduced since the time-critical synchronization between the illumination and the image recording already takes place within the time of flight and illumination module 12, 14 and the central control and evaluation unit 30 is relieved of this work. The explanations on the embodiment shown in FIG. 1 continue to apply accordingly to the individual components of the common time of flight and illumination module 12, 14. An embodiment is additionally shown having a plurality of illumination modules for one time of flight module. As a frontal view in accordance with FIG. 2b illustrates, an arrangement of four light sources 24a-d having upstream transmission optics 22a-d around the image sensor 16 is particularly suitable. This is only one example of possible deviations from a 1:1 association between time of flight modules 12_{1 . . . n} and illumination modules 14_{1 . . . n}.

The plurality of time of flight modules 12_{1 . . . n}, whether with separate or integrated illumination modules 14_{1 . . . n}, enables two unit concepts. On the one hand, the partial fields of view 28_{1 . . . n} of the time of flight modules 12_{1 . . . n} cannot be the same, that is cannot observe the same scene due to offset and/or orientation. The partial fields of view 28_{1 . . . n} are then assembled to form a common larger field of view. On the other hand, it is conceivable that the time of flight modules 12_{1 . . . n} observe the same scene and that the partial fields of view 28_{1 . . . n} consequently overlap one another to improve the detection capability. Finally, combinations are also conceivable, for instance overlaps of partial fields of view 28_{1 . . . n} in the marginal regions, or the partial fields of view 28_{1 . . . n} are arranged such that both the field of view expands and raw image data are acquired multiple times at least sectionally.

FIG. 3 shows a schematic plan view of a 3D camera 10 for the first-named case of a visual field extension. The 3D camera 10 is accommodated in a common housing 44 in the form of a regular n-gon, here an octagon. Time of flight modules 12_{1 . . . n} and illumination modules 14_{1 . . . n} can be respectively arranged at the sides of the n-gon, with two sides being occupied in the embodiment shown. The central control and evaluation unit 30 is seated in the interior. The flexible unit design concept enables a simple extension in a plane by a different number of time of flight modules 12_{1 . . . n} and illumination modules 14_{1 . . . n}, alternatively also stacked in a plurality of planes, with the control and evaluation unit 30 with its common connector 42 only being required once. A very flexible variant formation is thus possible in which different systems can be configured with different fields of view while using uniform modules 12_{1 . . . n}, 14_{1 . . . n}, with the development effort for the variant formation being small. The housing concept in accordance with FIG. 3 is particularly suitable for a common field of view that is a great deal wider horizontally then vertically and having a flat construction and good thermal connection to the top and bottom. Adjacent partial fields of view 28_{1 . . . n} can here have a certain overlap 46 in the marginal region.

FIG. 4 shows a schematic plan view of a time of flight module 12 with an integrated illumination module 14. It differs from the embodiment in accordance with FIG. 2 by a geometry and by a surrounding partial module housing 48 having a trapezoidal base area matching the common housing 44. This compact construction unit can be simply integrated in the common housing 44.

FIG. 5 shows a schematic plan view of a 3D camera 10 similar to FIG. 3, with the difference that here all the sides of the octagon are occupied to achieve an all-round view over 360°. In addition, the compact combined time of flight modules 12_{1 . . . 8} with illumination modules 14_{1 . . . 8} are used.

FIG. 6 shows a schematic plan view of a vehicle 50, in particular an automated guided vehicle (AGV) having a 3D camera 10 in accordance with FIG. 3, but with four occupied sides to horizontally monitor a common field of view of approximately 180° in the direction of travel. In the vertical direction, a comparatively small angle of view of, for example, 35°, is sufficient in such a 1×4 system.

FIG. 7 shows a sectional representation through a further embodiment of the 3D camera 10. In the sectional representation, two respective time of flight modules 12_{1 . . . 2} and two illumination modules 14_{1 . . . 2} can be recognized, with fewer or additional modules 12_{1 . . . n}, 14_{1 . . . n} still being conceivable. A special feature of this arrangement is that as a further variant, the time of flight modules 12_{1 . . . 2} and the illumination modules 14_{1 . . . 2} are arranged above one another instead of next to one another. The electronic components of the central control and evaluation unit 30 are likewise arranged in a space-saving manner centrally above one another. The common connector 42 is led out to the bottom or alternatively to the top so that a 360° field of view results horizontally and thus an omnidirectional 3D camera 10 become realizable. Thermal pads 52 can furthermore be provided at the top and bottom.

As FIG. 8a-b illustrates, the arrangement of modules 12_{1 . . . n}, 14_{1 . . . n} does not have to remain in one plane. The example illustrates a 2×2 module arrangement in a plan view in accordance with FIG. 8a and a frontal view in accordance with FIG. 8b. The field of view can thus be extended in two dimensions, with the number of modules 12_{1 . . . n}, 14_{1 . . . n} in both axial directions being purely by way of example.

Alternatively to a previously presented field of view extension it is also conceivable that time of flight modules 12_{1 . . . n} observe the same scene or at least a considerably overlapping scene. A higher pixel density in the 3D scatter cloud or in the three-dimensional image date is achieved by such a multiple observation. In addition, the illumination power is increased in the overlapping regions to thereby, for example, improve the measurement uncertainty or depth resolution. A synchronization of the modules 12_{1 . . . n}, 14_{1 . . . n} or of the image recording is required for this purpose. The compensation of the marginal light drop of the individual modules 12_{1 . . . n}, 14_{1 . . . n} is one application, but the redundant detection can also improve the quality of the three-dimensional image data in central regions. Further conceivable advantages of a multiple detection include additional information through different directions of view toward an object, for instance to reduce shading effects or for a partial elimination of multi-path effects, and an improved recognition of objects having directed reflection, that is reflective or shiny surfaces such as windows. The redundant scene detection can finally enable an autocalibration.

The individual modules 12_{1 . . . n}, 14_{1 . . . n} do not have to be arranged at a specific angle with respect to one another for this purpose. FIG. 9 shows an embodiment having two modules 12_{1 . . . 2}, 14_{1 . . . 2} and overlapping partial fields of view 28_{1 . . . 2}. The housing construction here even allows a variable arrangement at different angles and with a flexible distance. An actuator system 54 only shown very schematically is provided for this purpose, for instance on the basis of piezo actuators, that enables a displacement and/or tilting or rotation. The adaptation serves for the adjustment on the putting into operation and installation, but can even also be used for dynamic applications in ongoing operation.

FIG. 10 shows a further embodiment of a 3D camera 10 that combines a field of view extension with a multiple recording to improve the three-dimensional image data. In the specific example, four modules 12_{1 . . . 4}, 14_{1 . . . 4} are provided that in pairs observe the same scene in overlap regions 46a-b. A field of view therefore arises in comparison with an individual time of flight module 12_{1 . . . 4} which is approximately twice the size and in which the raw image data are simultaneously detected twice. The advantages of both approaches are thereby combined.

A purely 3D camera has previously been presented for the detection of three-dimensional image data. It is also conceivable to integrate further components and sensors, in addition to the modules 12_{1 . . . n}, 14_{1 . . . n}, to connect them to the central control and evaluation unit 30 and to include them in the data fusion. Some examples are one-dimensional or two-dimensional distance sensors, 2D monochrome cameras or color cameras so that in addition to depth measurement values a gray image or color image of the scene is also simultaneously recorded that can be directly superposed with the depth image, additional illuminations for such 2D cameras, for instance with white light, inertial sensors or acceleration sensors, in particular for the navigation of vehicles, target lasers, for instance for marking the center or the margins of the field of view in the scene, in particular for setup purposes, or RFID readers or code reader sensors for identifying objects.

1. A 3D time of flight camera for detecting three-dimensional image data from a detection zone, the 3D time of flight camera comprising a plurality of time of flight modules for detecting a partial field of view of the detection zone, with each time of flight module having an image sensor, a reception optics, and an interface for outputting raw image data and comprising at least one illumination module for transmitting a light signal into the detection zone, wherein the 3D time of flight camera further comprises:
a central control and evaluation unit that is connected to the time of flight modules and to the illumination modules to receive the raw image data and to generate the three-dimensional image data therefrom;
a common connector for outputting three-dimensional image data and/or data derived therefrom; and
a common housing in which the time of flight modules, the at least one illumination module, and the central control and evaluation unit are accommodated.

2. The 3D time of flight camera in accordance with claim 1,
wherein the common housing has the shape of a regular n-gon, where n>4, as a base area; and the time of flight modules are arranged at at least some sides of the n-gon and are outwardly oriented.

3. The 3D time of flight camera in accordance with claim 2,
wherein a detection zone of up to 180° or up to 360° is achieved along at least one dimension.

4. The 3D time of flight camera in accordance with claim 2,
wherein the time of flight modules have a housing having a base area in the form of a trapezoid or of a triangle matching a segment between a center and two adjacent corners of the n-gon.

5. The 3D time of flight camera in accordance with claim 1,
wherein at least some time of flight modules are combined with one or more separate illumination modules.

6. The 3D time of flight camera in accordance with claim 5,
wherein at least some time of flight modules are combined with one or more separate illumination modules in a common module housing.

7. The 3D time of flight camera in accordance with claim 1,
wherein the partial fields of view of the time of flight modules are different and complement one another to form the detection zone.

8. The 3D time of flight camera in accordance with claim 1,
wherein at least some of the partial fields of view at least partially overlap one another.

9. The 3D time of flight camera in accordance with claim 8,
wherein additional information is acquired in arising overlap regions, with the additional information being used for at least one of the purposes of reducing shading effects; partial elimination of multi-path effects; improved recognition of objects having directed reflection; local increase of the spatial resolution; or autocalibration.

10. The 3D time of flight camera in accordance with claim 1,
wherein at least some of the time of flight modules and/or the at least one illumination module have/has a movement unit for changing the partial field of view.

11. The 3D time of flight camera in accordance with claim 1,
wherein the central control and evaluation unit is configured to sequentially record raw image data of all the time of flight modules or individual time of flight modules.

12. The 3D time of flight camera in accordance with claim 1,
wherein the central control and evaluation unit is configured to simultaneously record raw image data of all the time of flight modules or of individual time of flight modules, with a mutual influencing being avoided by at least one of the measures of channel separation in the time range; frequency range; by means of code multiplex; or spatially by non-overlapping partial fields of view.

13. The 3D time of flight camera in accordance with claim 1,
wherein individual time of flight modules and/or illumination modules are selectively switched on and off as required in dependence on the situation.

14. The 3D time of flight camera in accordance with claim 1,
wherein the control and evaluation unit has an image data flow control to read the raw image data in a coordinated manner from the time of flight modules, with the image data flow control having a multiplex unit for the sequential reading of raw image data from a respective different time of flight module and/or a plurality of channels.

15. The 3D time of flight camera in accordance with claim 1,
wherein the central control and evaluation unit is configured for a preparation of the raw image data that comprises at least one of the steps of correction of object distortion of the reception optics; compensation of drifts; correction of the arrangement of the time of flight modules with respect to one another; combination of a plurality of raw images; or
consideration of calibration data.

16. The 3D time of flight camera in accordance with claim 1,
wherein the central control and evaluation unit is configured for a postprocessing of the three-dimensional image data after fusion of the raw image data.

17. The 3D time of flight camera in accordance with claim 16,
wherein the post processing of the three-dimensional image data comprises a data filtering; a data compression; a selection of regions of interest; data conversion into a desired output format; an object recognition; or an object tracking.

18. The 3D time of flight camera in accordance with claim 1,
wherein at least one of the following is connected to the central control and evaluation unit for inclusion in the data fusion: a one-dimensional or two-dimensional distance sensor; a 2D monochrome camera or color camera for superposing their images with the three dimensional image data; an illumination for 2D cameras; an inertial sensor; an acceleration sensor; a target laser for marking the center or the margins of the detection zone; an RFID reader or coder reading sensor for identifying objects; and/or
wherein the common connector has a common power supply and/or analog or digital inputs and/or outputs that are conducted at least partially over a common cable.

19. The 3D time of flight camera in accordance with claim 18,
wherein, if provided, the illumination for 2D cameras comprises white light; the target laser for marking the center or the margins of the detection zone is used for setup purposes; and/or the common connector has switching outputs as outputs.

20. A method of detecting three-dimensional image data from a detection zone, wherein raw image data from a plurality of partial fields of view of the detection zone are detected separately,
wherein the raw image data are collected centrally and the three-dimensional image data are generated therefrom; wherein the three-dimensional image data and/or data derived therefrom are output to a common connector; and wherein the detection of the raw image data and the generation of the three-dimensional image data from the raw image data takes place within a common housing.
